(19) United States
(12) Patent Application Publication
(10) Pub. No.: US 2011/0084421 A1
(43) Pub. Date: Apr. 14, 2011

(54) Ultraphobic Compositions and Methods of Use

(75) Inventors: David S. Soane, Chestnut Hill, MA (US); Michael C. Berg, Baltimore, MD (US); Noah A. Suddaby, Westhampton, MA (US); Kevin J. Lim, Honolulu, HI (US); William A. Mowers, Oldsmar, FL (US)

(73) Assignee: Soane Labs, LLC, Cambridge, MA (US)

(21) Appl. No.: 12/689,271

(22) Filed: Jan. 19, 2010

Related U.S. Application Data
(63) Continuation of application No. PCT/US08/71569, filed on Jul. 30, 2008.
(60) Provisional application No. 61/022,865, filed on Jan. 23, 2008.
(60) Provisional application No. 60/952,749, filed on Jul. 30, 2007.

(51) Int. Cl. B29C 39/00; C08L 79/02; C08L 25/06; C08L 23/06; C08L 83/00; C08L 39/00; C08L 63/00

(52) U.S. Cl. 264/219; 524/612; 524/577; 524/585; 524/588; 524/555; 523/400

(57) ABSTRACT

Compositions and methods are disclosed for imparting ultraphobicity to substrates. Ultraphobicity can be exhibited by superhydrophobicity, oleophobicity, or both. In some instances, techniques for imparting ultraphobicity can include the use of particles that are appropriately configured. For instance, the particles can be arranged to form a roughened surface that enhances and/or imparts ultraphobicity. In another instance, the particles can have surfaces that repel at least one of a oil-based liquid and a water-based liquid. For example, the particles can be attached to an ultraphobic-inducing composition (e.g., copolymer) that comprises at least one polyamine segment and a plurality of branch segments. Such particles can be mixed with a binder composition to form a coating or film for imparting the ultraphobic properties. Other embodiments are directed to other techniques that can also aid in imparting ultraphobicity.

### CROSS REFERENCE AND RELATED APPLICATIONS

The present application is a continuation of PCT International Application No. PCT/US2008/071569, filed Jul. 30, 2008, entitled “Ultraphobic Compositions and Methods of Use,” which claims the benefit of (i) a U.S. Provisional Patent Application bearing Ser. No. 60/952,749, filed Jul. 30, 2007, entitled “Self Cleaning Surfaces;” and (ii) a U.S. Provisional Patent Application bearing Ser. No. 61/022,865, filed Jan. 23, 2008, entitled “Ultraphobic Films and Coatings.” The entire contents of all above-listed applications are incorporated herein by reference in their entirety.

### FIELD OF THE APPLICATION

This application relates generally to compositions that can exhibit ultraphobic properties, and in particular to films, coatings, and other structures that can exhibit superhydrophobic and/or oleophobic properties.

### BACKGROUND

Surfaces can be modified to exhibit various characteristics, such as a phobicity to water-base liquids, oil-based liquids, or both. For example, a surface can exhibit a contact angle with a drop of water that is significantly more than 90 degrees, with a roll-off angle that does not exceed 10 degrees. A surface, where the contact angle with a water-based liquid is greater than about 140 degrees, exhibits superhydrophobic properties. Since such a surface may not be wettable with water, it may possess self-cleaning properties because dirt, soil or dust particles on the surface adhere to the liquids which flow over the surface.

In many instances, a hydrophobic surface may also be termed water-repellant. A hydrophobic surface will normally not support the formation of a water film, even of monomolecular thickness. Hydrophobic substances can include a number of materials such as oils, fats, waxes, as well as finely divided powders such as carbon black and magnesium carbonate. Analogously, an oleophobic surface may also be termed grease-repellant or oil-repellant. An oleophobic surface will normally not support the formation of an oil film, even of monomolecular thickness.

Hydrophobic and oleophobic surfaces are desirable in many commercial applications. For example, hydrophobicity is useful in a surface exposed to water or subject to ice and snow accumulation. Oleophobicity is useful for surfaces in which build up of lipid-based or oil-containing liquids is to be avoided. In some instances, hydrophobicity and/or oleophobicity can render a surface self-cleaning, so that contact with a liquid serves to wash away particulate matter residing on the surface. Such surfaces can also render substrates resistant to fouling and contamination in a variety of settings.

Various coatings or texture modifications have been used to impart hydrophobicity or oleophobicity to surfaces. Instances of some approaches to rendering surfaces ultraphobic, that is superhydrophobic and/or oleophobic, can involve roughening them or otherwise changing their surface properties, for example by introducing a micro- or a nano-texture that creates a layer of air between the liquid droplet and the surface that prevents the droplet from forming a connected layer on the surface. These technologies, however, are frequently expensive and inefficient for widespread use. Moreover, in many cases, the ultraphobic surface has poor resistance to abrasion and wear, so that it loses its ultraphobic properties as it is eroded or damaged. If the ultraphobic surface is a coating overlying a hydrophilic or oleophilic substance, erosion of or damage to the surface can result in significant undesirable effects.

There remains a need in the art, therefore, for compositions, formulations and methods for imparting ultraphobic properties to a variety of surfaces. It is further desirable that such ultraphobic properties be imparted by coatings or films that can be applied to disparate substances. Moreover, it is desirable that ultraphobic coatings or films be manufactured inexpensively and efficiently. In addition, it is desirable that such coatings, films and surfaces be wear-resistant and durable.

### SUMMARY

In embodiments, coating compositions are disclosed herein for imparting ultraphobicity. The coating compositions can exhibit at least one of superhydrophobicity or oleophobicity. The compositions disclosed herein can comprise a plurality of particles configured to impart texture to a surface, and an ultraphobic-inducing composition attached to the plurality of particles, the ultraphobic-inducing composition comprising at least one polyamine segment, with a plurality of branch segments attached to the at least one polyamine segment, the plurality of branch segments including at least one of a hydrophobic segment and an oleophobic segment. The branch segments of the coating composition can be covalently bonded to the at least one polyamine segment, or they may not be covalently bonded to the at least one polyamine segment. The ultraphobic-inducing composition can be attached to the plurality of particles using a multifunctional coupling agent. The multifunctional agent can comprise a functionality group including epoxy, hydroxyl, alkoxyl, or halogen. The multifunctional coupling agent can comprise a silane coupling agent. In embodiments, the ultraphobic-inducing composition can directly contact a surface of the plurality of particles. In embodiments, the at least one polyamine segment of the ultraphobic-inducing composition comprises chitosan.

The plurality of particles can comprise microparticles and/or nanoparticles. The plurality of particles can comprise inorganic particles and/or polymeric particles. The polymeric particles can be crosslinked. The polymeric particles can comprise at least one of polystyrene, silicone, polyethylene, and a fluorinated polymer. The inorganic particles can include an oxide particle. The plurality of particles can include fibers.

In embodiments, the ultraphobic-inducing composition comprises a copolymer composition. In embodiments, the copolymer composition can comprise a highly-branched copolymer. In embodiments, the polyamine segment of the ultraphobic-inducing composition can include at least one segment of polydiallylamine, polyalkyleneimines, chitosan, polyallylamine, or polyvinyladine. The polyalkyleneimine can be branched or linear. The branched polyalkyleneimine can be branched polyethyleneimine. The polyamine segment can also be attached to molecules having other functionalities, including a UV blocker, a dye, a thickener, a dispersing aid, a compatibility aid, a deposition agent, and a hindered amine light stabilizer.

The plurality of branch segments for the coating composition can comprise a fluoro-based segment, a silicone-based segment, or a hydrocarbyl-based segment. The plurality of branch segments can have at least a molecular weight of about 500 daltons. The plurality of branch segments can comprise a plurality of silicone-based segments.

In embodiments, the composition can further comprise a binder composition in contact with the plurality of particles, the plurality of particles imparting the textured surface by protruding from the binder composition. In embodiments, the plurality of particles can include a polyamine attached to the particle surface, and the ultraphobic-inducing composition can be a binder copolymer composition. In embodiments, the binder composition can comprise an oleophobic polymer. In other embodiments, the binder composition can comprise a hydrophobic polymer. In embodiments, coating compositions disclosed herein can form a free-standing film. In certain embodiments, the ratio of the plurality of particles to binder composition is less than about one on a weight basis. The particles in the coating composition can be more prevalent around an interface of the binder composition relative to a bulk region of the binder composition. At least a portion of the plurality of particles can form aggregates that increase the opacity of the coating composition to visible light relative to primary particles. In embodiments, the binder composition can comprise a binder copolymer composition. The binder copolymer composition can comprise a copolymer composition attached to the plurality of particles.

In other embodiments, methods are disclosed herein for rendering a substrate surface ultraphobic. In certain practices, the method can include the steps of contacting the substrate surface with a coating composition, the coating composition comprising a plurality of particles configured to impart texture to a surface, and a ultraphobic-inducing composition attached to the plurality of particles, the ultraphobic-inducing composition comprising at least one polyamine segment, and a plurality of branch segments attached to the at least one polyamine segment, the plurality of branch segments including at least one of a hydrophobic segment and an oleophobic segment, so that the contacted substrate surface exhibits ultraphobic properties. In embodiments, the method renders the substrate surface superhydrophobic. In other embodiments, the method renders the substrate surface oleophobic. The ultraphobic-inducing composition can comprise a highly-branched polymer. In embodiments, the plurality of particles in the coating composition can be aggregated. Aggregates of the plurality of particles can trap air to increase the coating composition opacity to visible light relative to primary particles. In embodiments, the aggregates of the plurality of particles can texturize the substrate surface.

In embodiments, the step of contacting the surface substrate with a coating composition includes attaching the at least one polyamine segment to the plurality of particles to form the coating composition, and applying the coating composition to the substrate surface. The substrate can include paper, wood, ceramic, fibrous material, glass or plastic. In embodiments, the step of attaching the at least one polyamine segment can comprise using a multifunctional coupling agent to attach the at least one polyamine segment to the plurality of particles. The multifunctional coupling agent can be attached to the at least one polyamine segment before attaching the copolymer to the plurality of particles. The multifunctional coupling agent can be attached to the plurality of particles before attaching the at least one polyamine segment to the plurality of particles. The step of attaching the at least one polyamine segment can comprise precipitating the at least one polyamine segment onto the plurality of particles, and/or attaching the at least one polyamine segment using an electrostatic interaction.

In certain practices of these methods, the coating composition can include a binder composition in contact with the plurality of particles, the plurality of particles imparting a textured surface to the substrate surface by protruding from the binder composition. The step of contacting the substrate surface with a coating composition can further comprise reacting a precursor of the binder composition to form the coating composition. In other embodiments, the step of contacting can further comprise adding the plurality of particles to the binder composition after reaction of the precursor of the binder composition is initiated. In other embodiments, the step of contacting can further comprise attaching the at least one polyamine segment to the plurality of particles to at least partially form the coating composition, and applying the coating composition to the substrate surface. The method can further comprise combining the polyamine-attached particles with a binder copolymer composition to form the coating composition.

Certain practices of these methods can include the step of forming the ultraphobic-inducing composition by non-covalently attaching the at least one polyamine segment and the plurality of hydrophobic segments. The method can further comprise forming a copolymer by reacting the at least one polyamine segment and the plurality of hydrophobic segments. The copolymer can comprise a highly-branched copolymer. The step of forming the copolymer can occur while the at least one polyamine segment is attached to the plurality of particles. The step of forming the copolymer can occur before the at least one polyamine segment is attached to the plurality of particles.

In certain practices of these methods, the step of contacting can further comprise mixing the plurality of particles with a binder composition to form the coating composition. The step of mixing can further comprise migrating the plurality of particles by self-assembly to a free surface of the binder composition, thereby forming a textured surface.

In other embodiments, methods for forming a free-standing film having ultraphobic properties are disclosed herein. In certain practices, the method can include the steps of forming a template having a surface with at least one ultraphobic property, contacting the template with a film-forming material to impart a texture of the template surface to the film-forming material, and removing the film-forming material from the template surface to preserve the texture of the template surface, thereby creating the free-standing film with ultraphobic properties. In embodiments, the at least one ultraphobic property of the template surface comprises a selected roughness texture. In embodiments, the ultraphobic properties of the free-standing film comprise at least one of superhydrophobicity and oleophobicity. In embodiments, the film-forming material comprises at least one of a hydrophobic composition and an oleophobic composition.

### DETAILED DESCRIPTION

Embodiments of the present invention are directed to compositions (e.g., coatings, films, and/or layers) and methods for rending a surface ultraphobic. As utilized herein, a surface is said to exhibit ultraphobic properties if the surface exhibits at least one of superhydrophobicity and oleophobicity. Accordingly, an ultraphobic surface can exhibit superhydrophobicity, oleophobicity, or both properties simultaneously. In some embodiments, the phobicity of the composition can result in a self cleaning surface. In some embodiments, the films and coatings can be fabricated with improved scratch- or abrasion-resistance, due, for example, to the presence of nanoparticles in the system, or due to the properties of the binder composition used with the ultraphobic composition.

While ultraphobicity is exhibited by many embodiments disclosed herein, in some instances the ultraphobicity can be imparted using an ultraphobic-inducing composition including particles that are used to impart texture to a surface that repels at least one of an oil-based liquid and/or a water-based liquid. Accordingly, the particles can intrinsically, or can be modified, to have a surface that chemically repels at least one of a water-based liquid or an oil-based liquid. For instance, the particles can have a copolymer (e.g., a highly-branched copolymer) attached thereto, where the copolymer can comprise one or more polyamine segments and a plurality of hydrophobic and/or oleophobic segments (herein “hydrophobic/oleophobic segments”). A binder composition can be combined with the particles to form a coating or film (e.g., a free-standing film). The disclosure herein discusses various aspects of types and distributions of materials that can be used with such particles/binder compositions. It is understood that other embodiments are also disclosed which can impart ultraphobicity without necessarily using the particle composition previously described.

As utilized within the present application, a surface exhibiting superhydrophobicity is one where a rolling droplet of water forms an advancing contact angle of greater than 140 degrees with the surface. In some instances, superhydrophobicity is further characterized by a receding contact angle that is within about 10 degrees of the advancing contact angle. A surface exhibits oleophobic properties when an oil-based or fat-based liquid forms a contact angle with the surface of greater than about 90 degrees.

The terms “attach,” “bind,” and “bound” are synonymous with each other and refer to a coupling between entities. Such coupling can either be direct, such as a polymer sharing a covalent chemical bond with a surface site of a particle together, or can be indirect, such as coupling a polymer and a surface site together using an intermediary agent which is directly coupled to the polymer and the surface site (e.g., a multifunctional coupling agent). Binding between entities can occur by any feasible mechanism consistent with an embodiment of the invention. Accordingly, non-limiting mechanisms by which chemical entities can be bound together include covalent bonding, non-covalent bonding, electrostatic (or ionic) forces, Van der Waals forces, hydrogen bonding, entanglement of molecular structures, other intermolecular forces, and combinations of the listed mechanisms.

The term “polymer” can refer to a molecule comprising a plurality of repeat units or monomers. A polymer can comprise one or more distinct repeat units. For example, a “copolymer” refers to a polymer having two or more distinct repeat units. Repeat units can be arranged in a variety of manners. For example, a homopolymer refers to a polymer with one type of repeat unit where the repeat units are adjacently connected. In another example, a plurality of different repeat units can be assembled as a copolymer. If A represents one repeat unit and B represents another repeat unit, copolymers can be represented as blocks of joined units (e.g., A-A-A-A-A-A . . . B-B-B-B-B-B . . . ) or interstitially spaced units (e.g., A-B-A-B-A-B . . . or A-A-B-A-A-B-A-A-B . . . ), or randomly arranged units. Of course, these representations can be made with 3 or more types of repeat units as well. In general, polymers (e.g., homopolymers or copolymers) include macromolecules in a broad range of configurations (e.g., cross-linked, linear, and/or branched). A “highly branched polymer” refers to a branched and/or cross-linked polymer where the molecule has a tendency to form a three-dimensional space filling structure. For example, a highly-branched polymer can have a configuration where the ratio of the number of branches with each of its ends connected to cross-linkages and/or branch points to the number of branches having a free end is greater than some designated value (e.g., greater than about 0.5, 0.6, 0.7, 0.8, 0.9, 1.0, 1.50, 2.0, or 5.0). The polymer can be disposed in a variety of mixture dispositions such as solutions, melts, and/or gels. A gel refers to a state where a mixture of polymer and liquid has at least some properties that make the mixture behave more like a solid than a viscous liquid (e.g., the mixture exhibits elasticity). Various embodiments described herein are directed to compositions, or use thereof, that include a polymer having one or more of the specific properties discussed above.

Unless otherwise specifically designated, polymers are distinguished from oligomers by the number of repeat units present. Oligomers typically include from about 2 to about 20 repeat units, whereas polymers typically utilize more than 20 repeat units.

As utilized in the present application, the term “segment” refers to a molecule or portion of a molecule such as a portion of a polymer. Accordingly, the segments can be polymeric segments (i.e., portions or the entirety of a polymer) or oligomeric segments that are reacted with other segments to form a copolymer molecule.

### Ultraphobic Particle Compositions

Some embodiments are drawn to techniques for imparting ultraphobicity using a composition that includes particles. Without necessarily being bound by any particular theory, the particles can impart the ultraphobicity by (i) imparting texture to a substrate surface to which the particles are applied; (ii) having a particle surface with a chemical nature that repels water-based and/or oil based liquids; or (iii) using both techniques; the latter can be preferred to impart ultraphobicity. Though a number of different embodiments are described herein, some particular embodiments utilize particles in which a ultraphobic-inducing composition is attached to the particles. For example, a copolymer, which can be a highly-branched copolymer, can be used, and can comprise one or more polyamine segments and a plurality of hydrophobic and/or oleophobic segments (e.g., silicone-based segments) which are attached to the polyamine segment(s). The polyamine segment(s) can be attached to the particles using covalent bonding with a coupling agent or can be adhered to the particle surface by electro-static interactions, among other intermolecular forces. In some instances, a binder composition is combined with the particles to form mixture that can be used as a coating or film (e.g., a free-standing film) or other material.

The following description of particles, copolymer, and binder components can be blended in the any workable combination to practice the aforementioned embodiments. For instance, the particle can be an inorganic oxide particle (e.g., silicon-dioxide based particle) in which chitosan is precipitated onto the particle surface. Silicone-based segments can be attached to the chitosan to form a highly-branched polymer coating the particle surfaces. Such copolymer-particles can be embedded in a hydrophobic binder matrix (e.g., polyhydroxystyrene). It should be understood, however, that the various components and types of components can also be used in other embodiments described in the present application without limitation. Accordingly, the particles, copolymer types and configurations, and binders can be used in any appropriate embodiment disclosed here without necessarily being used with respect to a copolymer-particle embodiment. As well, the systems, formulations and compositions disclosed herein can also include solvents, pigments, or other additives that would be deemed useful by those of ordinary skill in the art.

1. Particles

In some embodiments that utilize a plurality of particles, the particles can exhibit a variety of characteristics. For instance, particles can be aggregated or individually dispersed. Particles that are dispersed individually are termed “primary particles.” When two or more particles group together to form an aggregate, such particles are termed “aggregated particles.” In some embodiments, a particle, whether primary or agglomerated, can be used in its native form without modification. In other embodiments, a particle, whether primary or aggregated, can be modified, for example by attachment to a polymer, molecule, or other material; such particles are termed “modified particles.” A particle, whether primary or aggregated, upon which a modification is performed is termed a “base particle.”

Particles suitable for use with some of the embodiments can include any of micro- or nano-particles; other sizes can also be utilized. A mixture of microparticles and nanoparticles can be used in some embodiments. Microparticles are particles in which the average particle size is in the range of about 500 nm to about 500 microns. Nanoparticles are particles in which the average particle size is less than about 500 nm or less than about 100 nm. In some instances, the average size is greater than about 1 nm. The average particle size can be defined by a number of techniques, including those known to one skilled in the art. The average particle size can be defined as any of an average effective diameter based upon surface area measurement (e.g., BET) or other measurement (e.g., examination of micrograph image analysis) or a largest average dimension of the particles. These size ranges can be applied to the primary particles and/or the aggregate size of aggregated particles.

Particles used in embodiments of the invention can comprise any number of materials. Non-limiting examples include polymers, biopolymers, bio-oligomers, pigments, oxides (e.g., a metal oxide), silicas, inorganic components (e.g., any one of kaolin, calcium carbonate, and titanium dioxide), and mixtures of such materials. In particular embodiments, the particles have at least a surface comprising one or more the listed materials herein.

In embodiments, particles may be of any shape, including substantially spherical, amorphous, cylindrical, plate-like, flake-like, or any other geometry. In some embodiments, the particles can include one or more fibers. Fibers are particles that have an aspect ratio greater than 2:1 with respect to two directions. Types of fibers that can be utilized include cellulose-based fibers, such as those used to make paper products. In many embodiments, the fibers can have a net negative charge. Such net charge can be utilized advantageously in some embodiments to cause electrostatic attraction of cationic moieties such as polyamines. Though any type of compatible fiber can be utilized, in some embodiments the fibers exclude the presence of synthetic fibers such as polymer-based fibers (e.g., aromatic amide fibers). Thus, some embodiments utilize fibers that include substantially naturally-occurring fibers. Other embodiments, however, can utilize synthetic fibers such as polymer-based fibers (e.g., aromatic amide fibers) or other types of synthetic fibers.

While not being bound by any particular theory, some of the disclosed embodiments can impart ultraphobicity due, at least in part, to the roughness created at a surface by the particles. For instance, the particles can protrude from a binder composition, or the particles can just be deposited directly to a substrate to form a texturized surface with roughness. The roughness, which is typically irregular but can have periodicity, of the surface can hinder or prevent the formation of a water-based and/or oil-based layer(s), which can serve to increase the respective repelling of the solvent. In such embodiments, the ultraphobic properties on surfaces formed by these compositions and methods may be attributable to modifications of the surface morphology (i.e., the texturizing of a surface), and can be termed “surface-defined” ultraphobic properties. In some embodiments, aggregates of particles can be formed to create the nano-scale and/or a micro-scale rough surface texture, which can act alone or in combination with chemical properties of a particle surface and/or binder composition to impart hydrophobic or oleophobic properties to a surface. In some embodiments, the agglomerated particles can be less packed together on the surface, so that fewer are needed to produce, for example, an ultraphobic effect.

2. Particle Surface Chemical Interactions to Impart Ultraphobicity

In some embodiments, particles are used to impart ultraphobicity by having a particle surface chemical character that repels at least one of water-based liquids and oil-based liquid. In some instances, the surface chemical character can be intrinsic to the particles' native surface. For example, when polymeric particles are utilized, the particles can intrinsically exhibit hydrophobicity. Non-limiting hydrophobic particles can include, for example, crosslinked hydrophobic polymeric particles such as polystyrene beads, silicone beads, polyethylene beads, and Teflon beads.

In other instances, base particles can be selected independent of their intrinsic hydrophobicity and/or oleophobicity since the particle surfaces are treated to impart the desired repelling character. Accordingly, particles that have a native surface that is hydrophilic or only slightly hydrophobic can be made more hydrophobic by attaching hydrophobic materials (e.g., a hydrophobic chemical group) that increase the hydrophobic nature of the particle surface. One example is by using an inorganic particle composition that includes a binder composition having a hydrophobic component tending to coat the particles. In certain embodiments, a hydrophobic binder polymer component may not completely coat the base particles; in such cases, hydrophobic base particles may be preferred. As well, oleophobicity can be increased by attaching oleophobic materials to a particle surface that can increase oil-based liquid repulsion. Similarly, ultraphobicity can be enhanced and/or imparted by attaching an ultraphobic material to a particle surface.

Attachment of an appropriate material to a particle surface to impart a desired repelling character can be achieved in a number of manners. In some embodiments, a selected coupling agent can be bound to the particle surface, where the agent acts as an intermediary for attachment of another chemical entity. The selected coupling agent can aid in attachment of a chemical group to impart a selected repelling character, a functionalizing polymer such as an amine-containing polymer to aid binding of a surface-modifying material, and/or some other component (e.g., a dye component) to add other beneficial properties. For instance, the coupling agent can attach to the particle surface via a reaction with a hydroxide group previously residing on the particle surface or as part of the unreacted coupling agent.

In some instances, a multifunctional coupling agent can be employed. As used herein, the phrase “multifunctional coupling agent” refers to agents which include at least two distinct types of functional groups that can be used to bind to other entities (e.g., a filler particle surface and/or a dye component). Examples of multifunctional coupling agents include an agent with a silicon atom or silane group for direct linkage to the surface of a filler particle or other substrate. Multifunctional coupling agents can be any of a small-molecule, an oligomer, or even a polymer (e.g., a polyamine).

Though much of the following description is with reference to functional groups on a multifunctional coupling agent, it is understood that such groups can be utilized on other coupling agents as well within the scope of the present application.

In some embodiments, the multifunctional coupling agent can include a silicon-containing group and at least one other different type of functional group. Examples of other functional groups include an amine group, an amino group, an epoxy group, a hydroxyl group, a thiol group, an acrylate group, a carboxyl group, and/or an isocyano group. In one embodiment, the silicon-containing group can be a silane group. Instances of such groups can include an isocyanosilane, for example, a trialkoxy isocyanosilane such as trimethoxy isocyanosilane, triethoxy isocyanosilane, and/or triisopropoxy isocyanosilane. In certain embodiments, the multifunctional coupling agent may include an aminosilane, for example, a trialkoxy aminosilane such as triethoxy aminopropylsilane and/or trimethoxy aminopropyl silane. In certain embodiments, the multifunctional coupling agent may include an epoxy siloxane. The coupling agent can include triethoxy methacryloxypropyl silane. Though in many instances a multifunctional coupling agent is embodied as a bifunctional coupling having one silane group and one other group, it is understood that a multifunctional coupling agent can have one or more silicon-containing groups, and/or one or more other functional groups. It should also be understood that certain embodiments of multifunctional coupling agents need not include a silicon atom or a silane group.

In some embodiments, multifunctional coupling agents can be used to form hydrophobic/oleophobic particles from any inorganic particle (e.g., having an oxide surface) or a mixture of inorganic particles, including any metal oxide or siliceous particle. Examples of particles suitable for such modifications include kaolin, nano-clay, precipitated calcium carbonate, carbon black, titanium dioxide, and colloidal silica. In embodiments, nanoparticles, microparticles, and mixtures of the two can be used. To modify a particle so that it possesses hydrophobic/oleophobic properties, coupling agents such as silane coupling agents (e.g., trialkyloxysilanes) bearing a reactive group can be used to attach hydrophobic/oleophobic chemical groups (e.g., polymers or oligomers) to the particles. In exemplary embodiments, the coupling agents can include one or more silanes with mono or multiple functional reactive groups such as hydroxyls, alkoxy (e.g., methoxy or ethoxy), or a halogen along with at least one reactive group on at least one other end (such as an amine, thiol, epoxy, isocyanate, or hydroxyl) to couple to the polymer or oligomer. The trialkyloxysilane can also be used by itself to make the particle hydrophobic/oleophobic if a silane is chosen with an appropriate end (such as a silicone, fluorine-containing, or hydrocarbyl-containing end).

Though in the above illustration covalent bonding can cause connection of a functional group of a coupling agent with a particle surface and/or dye component, it should be understood that the functional group of a multifunctional coupling agent can induce binding by other mechanisms as well. The functional group can covalently link the agent to the particle surface; alternatively, the linkage may be non-covalent, ionic (e.g., electrostatic forces), or via Van der Waals forces, hydrogen bonds, and/or other intermolecular forces.

Any appropriate molecule(s) can be attached to a particle to impart hydrophobicity and/or oleophobicity to the particle surface. Some embodiments utilize one or more of a silicone-based segment, a hydrocarbyl-based segment, and a fluoro-based segment. Such embodiments can also utilize segments that have a combination of the characters of the segments (e.g., a fluoroaliphatic segment or a silicone segment attached to a fluorinated aryl group). In some embodiments, the segments have a group that allows reaction with a coupling agent. Examples include polymers or other molecules that can be attached to the particles such as silicones, fluorine-containing compounds (e.g., a fluorinated alkyl group), or alkyl chains with epoxy groups, anhydride groups, isocyanate groups, acid groups, and other reactive groups. As an example, a coupling agent like an aminosilane can bind a silicone epoxide to a base particle to form a hydrophobic modified particle suitable for use in these systems. It is understood, however, that in some circumstances, the segment can bind directly to a particle surface without the use of any intermediary.

Within the scope of some embodiments disclosed in the present application, different types of silicone-based segments can be utilized. In some embodiments, a silicone segment can be a polymeric or oligomeric segment. Such polymeric segments can include a repeat unit represented by Structural Formula (I):

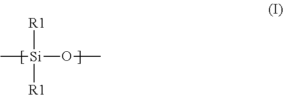

where each R1 in Structural Formula (I) is independently a substituted or unsubstituted hydrocarbyl group, a hydrogen, or a hydroxyl group. Hydrocarbyl groups that can be utilized include both aliphatic and aryl groups that can be optionally substituted with another aliphatic functionality and/or a heteroatom functionality (e.g., any combination of sulfur, oxygen, or nitrogen). Hydrocarbyl groups can include any number of carbon atoms such as 1 to 30, or 1 to 20, or 1 to 10 carbon atoms. Non-limiting examples of hydrocarbyl groups include a vinyl group; a substituted or unsubstituted phenyl group, such as unsubstituted phenyl and phenyl substituted at one or more positions with methyl, ethyl, or propyl; and substituted or unsubstituted alkyl groups, such as alkyl groups with 1 to 4 carbons, or more particularly methyl or ethyl. Accordingly, in some embodiments, each R1 can independently be a hydrocarbyl group containing 1 to 10 carbon atoms, a hydrogen, or a hydroxyl group; or each R1 can independently be an alkyl group with 1 to 4 carbon atoms, phenyl, vinyl, or hydrogen; or each R1 can independently be hydrogen, phenyl, or methyl. In some embodiments, a hydrocarbyl group can be substituted with fluorine. In a particular embodiment, the silicone segments can include one or more polydimethylsiloxane (“PDMS”) segments.

The phrase “hydrocarbyl-based segment” refers to a molecule that has properties similar to a hydrocarbyl group as discussed above with respect to substitutions on the silicone-based segments. Accordingly, hydrocarbyl-based segments can be small molecules, oligomers, polymers, or copolymers, which can have a number of multiple bonds, and/or can be substituted with non-hydrocarbon portions. Thus, hydrocarbyl-based segments can include any of an alkyl group, an alkenyl group, an alkynyl group, and an aryl group. Hydrocarbyl-based segments can also be configured in a variety of structural manners such as straight chained, branched, and/or with one or more ringed structures.

The terms “alkenyl” and “alkynyl” refer to unsaturated aliphatic groups analogous in length and possible substitution to the alkyls described above, but that contain at least one double or triple bond respectively.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups. In preferred embodiments, a straight chain or branched chain alkyl has 30 or fewer carbon atoms in its backbone (e.g., C₁-C₃₀ for straight chains, C₃-C₃₀ for branched chains), and more preferably 20 or fewer. Likewise, preferred cycloalkyls have from 3-10 carbon atoms in their ring structure, and more preferably have 5, 6 or 7 carbons in the ring structure.

Moreover, the term “alkyl” (or “lower alkyl”) as used throughout the specification, examples, and claims is intended to include both “unsubstituted alkyls” and “substituted alkyls”, the latter of which refers to alkyl moieties having substituents replacing a hydrogen on one or more carbons of the hydrocarbon backbone. Such substituents can include, for example, a halogen, a hydroxyl, a carbonyl (such as a carboxyl, an alkoxycarbonyl, a formyl, or an acyl), a thiocarbonyl (such as a thioester, a thioacetate, or a thioformate), an alkoxyl, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. It will be understood by those skilled in the art that the moieties substituted on the hydrocarbon chain can themselves be substituted, if appropriate. For instance, the substituents of a substituted alkyl may include substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Exemplary substituted alkyls are described below. Cycloalkyls can be further substituted with alkyls, alkenyls, alkoxys, alkylthios, aminoalkyls, carbonyl-substituted alkyls, —CF₃, —CN, and the like.

The term “aryl” as used herein includes 5-, 6-, and 7-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.” The aromatic ring can be substituted at one or more ring positions with such substituents as described above, for example, halogen, azide, alkyl, aralkyl, alkenyl, alkynyl, cycloalkyl, hydroxyl, alkoxyl, amino, nitro, sulfhydryl, imino, amido, phosphate, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more cyclic rings in which two or more carbons are common to two adjoining rings (the rings are “fused rings”) wherein at least one of the rings is aromatic, e.g., the other cyclic rings can be cycloalkyls, cycloalkenyls, cycloalkynyls, aryls and/or heterocyclyls.

Fluoro-based segments include small molecules, oligomers, and polymers that include one or more atoms of fluorine. Such segments can exhibit hydrophobic and/or oleophobic properties. In some embodiments, the fluoro-based segment can comprise a fluorinated hydrocarbyl portion such as a fluorinated organic polymer segment. A simple example of fluorinated polymer segments include polyethylene segments substituted with any amount of fluorine. In other examples, a fluorinated hydrocarbyl segment can be embodied as an oligomeric segment having 3 to 20 carbon atoms. In preferred embodiments, the fluorinated hydrocarbyl segment is multiply substituted with fluorine. Examples include segments substituted with 3, 4, 5, or more fluorine atoms residing on a saturated carbon backbone with 3 to 10 carbons, or an aryl group substituted by one or more fluorine atoms. The fluorinated hydrocarbyl can have any of the properties and structures discussed with respect to hydrocarbyl-based segments (branching, saturation, substitution etc.), albeit with at least one fluorine atom incorporated therein. Fluoro-based segments can be useful due to their ability to phase separate from hydrocarbyl-based segments. This property can help particles with attached fluorinated materials migrate to the surface after a coating solution is applied. Fluorinated materials can also be useful to impart oleophobicity due to the low surface energies often associated with such materials.

To amplify the hydrophobicity/oleophobicity of a particle, a polyamine can be attached to a particle. Polyamines are amine-containing polymers or polymer segments. The amine groups can act as reaction points for attachment of other entities having appropriate functional groups. Such entities can act to impart hydrophobicity and/or oleophobicity. Other entities can also be reacted to the amine groups to impart other desirable properties. Non-limiting examples of additional entities include a UV blocker, a dye, a thickener, a dispersing aid, a compatibility aid, a deposition agent, and a hindered amine light stabilizer. Examples of polyamines include aliphatic amine-containing polymers and chitosan. Specific examples of aliphatic amine-containing polymers include polydiallyl amine, polyallyl amine, polyvinyl amine, polyalkylenimine, and the like.

Attachment of a polyamine to a particle can take place in any number of manners. For example, the polyamine can be attached to a coupling agent first, followed by attachment with a hydrophobic molecule or an oleophobic molecule—followed by attachment to the particle surface. Any of the attachments can be accomplished by mechanisms such as covalent bonding, electrostatic or ionic interactions, van der Waals forces, and other molecular forces. In some instances, attachment of the polyamine to the particle surface can take place without the use of a coupling agent if the polyamine has a portion capable of attachment to the particle surface by any of covalent bonding, electrostatic or ionic interactions, van der Waals forces, and other molecular forces. For example, in some embodiments, polyamines can also self-assemble on the surface of the particles without the need of an intermediary agent. The amine groups can have a natural affinity for a negatively charged surface, resulting in an electrostatic or attractive ionic interaction. They can also be precipitated onto the surface, as is seen with chitosan, for example. Since chitosan is typically soluble in acidic aqueous conditions, it can be precipitated onto the surface of particles by suspending the particles in an acidic aqueous chitosan solution and then raising the solution pH. Other hydrophobic polymers can be added onto the surface of the particle without using a crosslinking agent as well. These polymers can be precipitated onto the surface of the particles, spray-dried with the particles, or attached to the particles using any of the techniques familiar to artisans of ordinary skill in the field.

Some particular embodiments are directed to ultraphobic compositions in which a copolymer is attached to particle surface. Such copolymers, which can be branched, can include at least one polyamine segment and a plurality of branch segments, which can be attached to a polyamine segment. Such branch segments can include one or more of hydrophobic segments and oleophobic segments. Without limiting the scope of the present invention, it is believed that the particular types of hydrophobic/oleophobic segments (e.g., silicone-based segments, hydrocarbyl-based segments, and/or fluoro-based segments) can impart water repellency and/or oil repellency properties to the particle surface. As well, it is believed that the hydrophobic/oleophobic segments can improve the copolymer's tendency to exhaust from a mixture (i.e., lower concentrations of polymer in a polymer mixture can be utilized to treat particles when the polymer is soluble in the mixture but close to coming out of solution). Some examples of specific types of these copolymers are described in a PCT Application bearing International Publication Number WO 2008/051221, filed Oct. 23, 2006; and a PCT Application bearing International Publication Number WO 2008/066849, filed Nov. 28, 2007. Both of these applications are incorporated herein by reference in their entirety.

In general, copolymer attachment can be performed in any suitable manner to obtain the modified particle. For instance, in some embodiments, a copolymer is first formed, followed by its attachment to particles (e.g., via a coupling agent which can be attached to the particles and/or copolymer first, or by other molecular forces allowing deposition of at least one segment of the copolymer to the particle surface). In another instance, segments of the copolymer can first be attached to particles (e.g., depositing polyamine segments such as chitosan onto inorganic particles), with the remaining segments subsequently attached to the previously attached segments (e.g., attaching silicone-based segments to the deposited polyamine segments). In such an instance, the copolymer can be branched, but can also not be highly-branched.

While in many embodiments the segments are covalently bonded together to form a copolymer, in alternate embodiments segments can be attached by other molecular forces (e.g., electrostatic, van der Waals, ionic, steric entrapment, etc.). For example, polyamine segments can be precipitated onto an anionic surface of an inorganic particle. Subsequently, branch segments having an anionic nature (e.g., a silicone segment bearing an acid group) can be exposed to the polyamine-coated particles, with the anionic portions causing adhesion between the branch segments and one or more polyamine segments. Accordingly, the combination of polyamine segment(s) and branch segments can form an ultraphobic-inducing composition without necessarily forming a covalently bonded copolymer.

In some particular embodiments, each branch segment can be attached to at least two distinct polyamine segments (i.e., each polyamine segment has a distinct backbone relative the other polyamine segments). These embodiments can promote the formation of a highly-branched copolymer molecule, with the branch segments acting as hydrophobic/oleophobic connectors between the polyamine segments. Though the copolymer can take on any molecular weight value, in some embodiments the average molecular weight of the copolymer can be large when the copolymer forms a highly-branched structure. For example, the average molecular weight of a copolymer can be greater than about 100,000 daltons or sometimes greater than about 500,000 or about 1,000,000 daltons.

Measurement of the average molecular weights for any polymer discussed herein can be with respect to a number of bases. For example, can be number averaged, weight averaged, or averaged based on some other weighting factors. As well, the techniques utilized to determine molecular weight can include the range of those known to those skilled in the art. Examples include gel permeation chromatography and light-scattering. In the use of chitosan, molecular weights can be measured in terms of a viscosity of a mixture.

Without necessarily being bound by theory, it is believed that when particles are contacted with the copolymer, consistent with embodiments described herein, the polyamine segments can tend to assemble onto the particle surface through electrostatic interactions. For example, when the polyamine segment includes a portion of a polyalkyleneimine, the residual charge density of the amine groups on the backbone is conjectured to interact with the particle surface, and induce assemblage thereon. In some instances, it is believed that the polyamine segments can form crystalline-like domains, which can substantially improve the affinity between the copolymer and the particle surface. Furthermore, it is believed that copolymers can be in the form of a highly-branched copolymer molecule, which can be readily deposited to a particle surface, thereby providing additional stability/affinity for the copolymer on the surface.

It is understood, however, that some embodiments of the invention utilize the copolymer in a manner such that the copolymer is covalently attached to the particle surface (e.g., connecting a polyamine position to a location of the particle surface via a coupling agent).

A variety of polyamine segments can be utilized with various embodiments described herein. Polyamine segments can be naturally occurring macromolecules with amine groups such as chitosan, or various types of synthetic polymers (e.g., copolymers) bearing amine groups. In some embodiments, the plurality of polycationic segments can include one or more aliphatic amine polymer segments. Aliphatic amine polymers include aliphatic polymers having one or more amine groups in each of a repeat unit of the polymer. Non-limiting examples of aliphatic amine polymers include polyalkyleneimine, polyvinylamine, polyallylamine, and polydiallylamine. Polyalkyleneimine segments can utilize about 2 to about 10 carbon atoms in the backbone (e.g., polyethyleneimine using two carbons) and can also include a mixture of lengths of polyalkyleneimines. Aliphatic amine polymers can also include copolymers having repeat units of different types of aliphatic amine homopolymers, such as copolymer utilizing repeat units of the examples of aliphatic amine polymers. It is also understood that mixtures of different types of polyamines can be utilized.

Consistent with embodiments disclosed herein, polyamine segments can bear a multiplicity of secondary amines (e.g., polyalkyleneimines) which can be reacted with other segments at the secondary amine locations to connect distinct polyamine segments. This can help promote formation of a highly-branched copolymer molecule. It is understood, however, that some copolymer segments, such as branch segments, can form loops along a single polyamine segment of the copolymers as well. Though the presence of secondary amines can promote the formation of copolymers consistent with embodiments disclosed herein, it is generally understood that the amine groups of a polyamine segment can include primary, secondary, tertiary, or quaternary amines. For example, the presence of some quaternary amine groups can help promote dispersion of a copolymer in an aqueous solvent.

While amine groups can be used to attach branch segments, as discussed earlier, amine groups can also be used to attach a variety of other components. Such components can include any one or more of a UV blocker, a dye, an optical brightening agent, a thickener, a deposition agent, a hindered amine light stabilizer, and a fragrance material.

Polyamine segments employed with various embodiments can have a variety of molecular weights and molecular weight ranges. In some embodiments, a desirable molecular weight range for the polyamine segments is large enough to promote branch formation of the copolymer and small enough such that the polyamine segment can be dispersed in a solvent without undue effort. For example, in some embodiments, the polyamine segments (e.g., polyalkyleneimines such as polyethyleneimine) can have an average molecular weight greater than about 100,000 Daltons. In some other embodiments, the polycationic segments (e.g., polyalkyleneimines such as polyethyleneimine) have an average molecular weight between about 10,000 Daltons and about 2,000,000 Daltons, or between about 100,000 Daltons and about 500,000 Daltons.

Generally, polyamine segments (e.g., polyalkyleneimine segments such as polyethyleneimine) can be either linear or branched to various degrees. For example, polyamine segments such as polyethyleneimine can be linear or branched or a mixture of the two. In some embodiments, branched polyalkyleneimines (e.g., polyethyleneimine) can be preferred since its synthesis is relatively inexpensive versus the linear product. However, other embodiments can utilize substantially linear polyamines as well.

With regard to branch segments that are attached to the polyamine segments, the segments can all be identical or can different in character and/or size. For instance, the segments can be silicone-based segments having a variety of sizes and/or substituents thereon. In another instance, the segments can include a mixture of any combination of silicone-based segments, hydrocarbyl-based segments, and fluoro-based segments. The silicone-based, hydrocarbyl-based, and/or fluoro-based segments can have any combination of the properties previously discussed with respect to such segments (e.g., the discussion with respect to attaching segments to particles), so long as such properties are consistent with embodiments discussed herein.

As an example, chitosan coated particles can be prepared in a manner as discussed in Example 10. The particles can be mixed in isopropanol (or other suitable solvent for the reactive material) and a reactive material that includes a glycidyl ether group on a hydrocarbyl group. Non-limiting examples include C8-C10 aliphatic glycidyl ether, C12-C₁₄ aliphatic glycidyl ether, 2-ethylhexyl glycidyl ether, Nonyl phenyl glycidyl ether, phenyl glycidyl ether, and castor oil triglycidyl ether (any of which are available from CVC Specialty Chemicals, Moorestown, N.J.). After approximately 1 hour of reaction time with stirring, the modified particles can be filtered and dried. These modified particles could be used with a hydrophobic binder, such as those listed in other examples, and a solvent to form a solution that when cast over a surface would render the surface superhydrophobic.

In another example, chitosan coated particles can be prepared in a manner as discussed in Example 10. The particles can be mixed in isopropanol (or other suitable solvent for the reactive material) and a reactive material that can be a fluorinated materials with a group reactive to an amine, a fluorinated alkane substituted 3 or 4 member heterocycle, and/or a fluorinated epoxy resin. After approximately 1 hour of reaction time with stirring, the modified particles can be filtered and dried. These modified particles could be used with a hydrophobic binder, such as those listed in other examples, and a solvent to form a solution that when cast over a surface would render the surface superhydrophobic.

In some embodiments, the branch segments (e.g., silicone segments) can include one or more functional groups for reacting with a portion of a polyamine segment to produce attachment. Such functional group(s) can be located at a terminal end of a branch segment, or in the neighborhood of a terminal end, or anywhere within the branch segment. In one embodiment, a branch segment can include an amine-reacting functionality at each of two terminal ends of the branch segment. Such a segment can be used to attach each of the functionalized ends to a distinct polyamine segment, which can be beneficial for forming a highly-branched copolymer molecule. Other branch segment embodiments can utilize three or more functional groups such that a branch segment can bind in more than two places with one or more polyamine segments.

The chemical nature of the functional group of a branch segment can be selected to allow reaction between the functional group and an amine site on a polyamine segment. Non-limiting examples of such functional groups include epoxides, isocynates, alkyl halides (e.g., methylchloryls), anhydrides, and other amine-reacting functional groups known to those skilled in the art.

The branch segments (e.g., silicone-based segments), which can be used with copolymers consistent with embodiments revealed in the present application, can span a variety of sizes and structures. For instance, the segments can be hydrophobic/oleophobic, branched, linear, and/or can have a variety of molecular weights. In general, the molecular weight of the hydrophobic/oleophobic segments can be selected to alter the end properties of the copolymer (e.g., ability to exhaust from a mixture). In some embodiments, the average molecular weight of the hydrophobic/oleophobic segments (e.g., silicone segments such as PDMS segments) is greater than about 500 Daltons and less than about 200,000 or about 10,000 Daltons.

3. Binder Composition Components

Binder compositions suitable for use with some embodiments of the invention typically include materials for forming a coating or layer in which particles are included. In many embodiments, these compositions can include polymers such as film-forming polymers or curable polymers that can form layers and coatings. In some embodiments, the binder composition includes components capable of forming a free-standing layer, i.e., a layer that has sufficient integrity that it does not require a backing material.

In many embodiments, binder compositions include a material capable of repelling at least one of water-based liquids and/or oil-based liquids. While not necessarily being limited by any particular theory, in some embodiments it is believed that that particles with surfaces that are hydrophobic can be distributed on the surface of a hydrophobic binder to impart a degree of roughness that can result in superhydrophobicity. Accordingly, the use of a hydrophobic substance, such as a hydrophobic polymer, can be beneficial in binder compositions. As well, oleophobic oligomers, polymers, and materials can also be used in binder compositions. In other embodiments, however, the particle surfaces or binder surface can be less hydrophobic than the complementary binder surface or particle surfaces. For example, a hydrophobic particle surface that imparts roughness on a underlying surface (e.g., substrate or binder surface) can act to hinder and/or prevent contact of a water-based droplet with the underlying surface. In another example, particles that have a hydrophilic surface can be coated by a binder composition, with the surfaces of at least some of the particles protruding to form a roughened surface.

Non-limiting examples of polymers that can be included in a binder composition include any combination of cellulose esters (preferably with low hydroxyl group content), polyurethanes, polystyrene, silicones, polyolefins, and polyacrylates. A mixture of polymers and/or copolymers can be used as the binder. In embodiments, the binder can be reacted as a precursor composition (e.g., of monomers or oligomers) that is subsequently cured or polymerized after being applied as a coating. As would be understood by those of ordinary skill in the art, curing or polymerization could occur through techniques such as photo-initiation, thermal initiation, or any other polymerization technique. In some embodiments, particles are added to the precursor of a binder composition after reaction is initiated. In some circumstances, this can allow a composition to increase its viscosity such that particles tend to reside at the surface of the reacting binder composition—which can aid in texturized surface formation.

In embodiments, a mixture of polymers and monomers or oligomers can be used as the binder, forming, for example, an interpenetrated network. In embodiments, the binder can be natively hydrophobic, or it can be modified with other additives such as surfactants or hydrophobic polymers to make it hydrophobic.

In some embodiments, the binder can contain silicone. Examples of binder systems include polyethylenimine (branched or linear) with silicone epoxies attached to the amine groups, or silicone epoxy systems cured through either addition of a UV initiator or an amine. Thus, some embodiments utilize a binder composition that includes an ultraphobic-inducing composition (e.g., a copolymer composition) having at least one polyamine and a plurality of hydrophobic/oleophobic segments attached to the polyamine segment. Such ultraphobic-inducing compositions can include any of the properties and configurations described in the present application.

Binder compositions that include a polyamine/hydrophobic/oleophobic composition (e.g., copolymer) can be used with particles that are not previously rendered ultraphobic. In some embodiments, a binder composition comprising at least one polyamine segment and a plurality of hydrophobic/oleophobic segments (e.g., chitosan segment(s) and silicone segments) is exposed to particles having a polyamine attached to the particle surface. Such a composition can be used to form an ultraphobic film, coating, or other material. Without necessarily being bound to any particular theory, it is believed that the polyamine, which can potentially only partially cover the particle surface, can thereby help create roughness on the particle surface. The polyamine can become entangled and/or react with the binder composition (e.g., copolymer), with the binder composition imparting further ultraphobic properties.

### Ultraphobic Compositions Utilizing Low Particle: Binder Ratios

In some embodiments, the particle-to-binder ratio in an ultraphobic composition is advantageously selected to be low, for example, less than 60% particles by weight, or less than 50% particles by weight (e.g., a particle to binder weight ratio less than about 1), or less than 30% particles by weight, or less than 20% particles by weight. In embodiments, the particles and the binder can have a high interfacial tension that prevents the binder from wetting the surface of the particles and thereby results in the particles migrating to a free surface of the system before the system hardens as a film or a coating. Not to be bound by theory, a high interfacial tension between the particles and binder can cause the particles to migrate to the surface to lower their contact area with the binder. In such embodiments, a desirable roughness can be achieved without a high particle loading, because the particles have a tendency to reside at the surface of the film or coating. Thus, in some embodiments, the particles in an ultraphobic composition are more prevalent (e.g., have a higher relative concentration) close to the interface of a coating relative to a bulk region (i.e., substantially removed from an interfacial region).

In embodiments, ultraphobic systems can be formed with fewer particles relative to binder by using particles that tend to migrate to the surface of the film. To achieve this, one can use particles that are incompatible with the polymeric binder and/or solvent, so that the chemical differences between the particles and the binder and/or solvent can cause them to phase separate from the matrix. With the evaporation of the solvent, or with the film-formation of a non-volatile binder, the particles can migrate to the surface of the residuum. As an example, silicone-coated particles can be suspended in a polymeric binder that can phase-separate from the silicone. Such a binder can be formed from a variety of hydrophobic polymers that are not miscible with silicone, for example certain acrylics or polyurethanes.

In embodiments, particles that are less dense than the binder can migrate to the upper surface of the coating or film during drying or curing, if, for example, the coating or film is applied to a horizontal surface. In embodiments, particles that are more dense than the binder can migrate to the lower surface of the coating or film during drying or curing if, for example, the coating or film is applied to a horizontal surface. It may desirable to have a lower particle-to-binder ratio for various applications, for example, to produce more transparent films, or to enhance film integrity. A variety of methods can be employed to disperse the particles advantageously within the binder. For example, physical means such as centrifugation can be used to direct the particles to a surface of the binder. As another example, differences in surface energy of the particles vs. the binder can be manipulated, so that particles are directed to the binder surfaces.

Particles can be added to an ultraphobic composition in a processing step while the binder is curing and/or drying. This sequence can result in many particles staying on the surface of the film. The particles could also be added with a solvent that swells the binder composition or that partially dissolves the binder composition so that the particles become better embedded in the binder and bonded thereto. In embodiments, particles can be functionalized with amines such as amino silanes or precipitated chitosan so that the particles can adequately attach to the binder when added to the binder in a separate processing step, with the addition of solvent as necessary. This approach can be advantageous for certain binders, e.g., epoxy-based binders that react with amine groups.

It is understood that the practice of low particle:binder ratio ultraphobic embodiments is not restricted to the specific disclosure of materials (e.g., binders, particles, and particle coatings) within the present application. Indeed, a variety of other materials and configurations can be utilized with the scope of the present invention, including those with the knowledge of one skilled in the art.

### Tailored Optical Properties of an Ultraphobic Coating/Layer

In embodiments, specific optical properties can be imparted to the surface. For example, the transparency of a film or coating can be modified by adjusting the compatibility of the particle and binder, i.e., by choosing a particle and a binder having a specific interfacial tension and/or differences in polarity. Particles that are extremely incompatible with each other (e.g., a silicone-coated particle suspended in a polar binder) can aggregate and trap air in their interstices. These aggregations with entrapped air can scatter light due to the difference in index of refraction between the air and the particles, so that the coating or film is rendered opaque. Particles that are more compatible with the binder can disperse more homogeneously in the binder, trapping less air and resulting in a more transparent or translucent film or coating. The compatibility between binder and particle can be affected through surfactants or other additives that change the interfacial tension between the particle and binder.

### Ultraphobic Coating/Layer Templates

In embodiments, the addition of particles to the system can be decreased or even eliminated if an ultraphobic film in accordance with the foregoing systems and methods is used as a first layer to create a mold or a surface template. After a film or coating has been created as described above having certain surface-defined ultraphobic properties, a hydrophobic/oleophobic film-forming material (e.g., comprising polymers, oligomers and/or monomers) can be applied to it as a second layer, using the first film or coating as a template. Suitable materials for the second layer can include materials such as siloxane-based material (e.g., polydimethyl siloxane epoxides), fluoro-based materials, and hydrophobic polymers such as organic polymers; crosslinkable and/or curable polymeric systems can be used. Polydimethyl siloxane epoxides useful for these purposes can be crosslinked using amine-containing molecules or moisture from the air, in ways similar to those described above for the hydrophobic binder system. When the system cures or dries, the top layer can assume the negative surface texture of the underlying ultraphobic film or coating, and can replicate its roughness.

In embodiments, binders for the top layer can desirably include those with low shrinkage such as solvent-less systems, for example, epoxy systems. In embodiments, silicone polymers can be advantageously used.

In embodiments, the ultraphobic polymer system described herein can be useful as a coating for a variety of underlying substrates, including wood, ceramics, metals, plastics, paper, and the like. Ultraphobic compositions can also be formed as a free standing film. Solvents can be present if needed. For particle-binder systems, it is understood in the art that a solvent can affect the drying time of a film or coating, which in turn can affect the ability of the embedded particles to migrate to the surface of the coating. For such systems, it would be understood in the art that faster drying can produce less particulate migration for a given system. For particle-binder systems, the overall concentration of the particles with respect to the binder can be varied according to the desired characteristics of the system, for example, its desired viscosity or other rheological properties. A coating or film in accordance with these systems can be applied to a substrate using any known coating technique such as roll coating, knife coating, hot melt coating, extrusion, and the like. The system can also be used to produce a free-standing film.

For those systems where constituent polymers or other materials are oleophobic, the resultant films or coatings can also display oleophobicity as well as superhydrophobicity. In embodiments, the films and coatings can be fabricated with improved scratch- or abrasion-resistance, due, for example, to the presence of nanoparticles in the system, or due to the properties of the binder.

### EXAMPLES

The following examples are provided to illustrate some aspects of the present application. The examples, however, are not meant to limit the practice of any embodiment of the invention.

Materials Used:
LPEI (Linear polyethylenimine): Produced on-site by deacetylating poly(2-ethyl-2-oxazoline) with acid hydrolysis. (Approximately 215K MW after acid hydrolysis) (Poly(2-ethyl-2-oxazoline) obtained from Sigma Aldrich #373974 St. Louis, Mo.)
BPEI (Branched polyethylenimine) (˜25,000 MW) (Obtained from Sigma Aldrich #408727)
Si 1K Di: Poly(dimethylsiloxane), diglycidyl ether terminated (980 MW) (Obtained from Sigma Aldrich #480282 St. Louis, Mo.)
Poly(dimethylsiloxane), epoxy functionalized (1100 MW) (Obtained from Gelest, EMS-924, Morrisville, Pa.),
1 k Mono: Poly(dimethylsiloxane), mono epoxy propylether terminated (1000 MW) (Obtained from Gelest, MCR-E11, Morrisville, Pa.)
7 k Di: Poly(dimethylsiloxane), chloromethyl terminated (7000 MW) (Obtained from Gelest, DMS-L21, Morrisville, Pa.)
SF8411: Poly(dimethyl/methyl-epoxy siloxane), (Obtained from Dow Corning Toray Silicones Co., Tokyo, Japan)
UV9300: Poly(dimethylsiloxane) copolymer, epoxy functionalized, (Obtained from Momentive Performance Materials Waterford, N.Y.)
Irgacure250 (Photoinitiator), (Obtained from Ciba #8293657AD Tarrytown, N.Y.)
CG110 (Chitosan), (Obtained from Primex, Siglufjordur, Iceland)
Poly 4-hydroxystyrene (Obtained from Sigma Aldrich #480282 St. Louis, Mo.)
Triethoxy isocyanopropyl silane (Obtained from Gelest Morrisville, Pa.)
7 nm silica (Obtained from Sigma Aldrich #480282 St. Louis, Mo.)
CAB-171-20 (Cellulose acetate butyrate) (Obtained from Eastman Kingsport, Tenn.)
CAB-171-15 (Cellulose acetate butyrate) (Obtained from Eastman Kingsport, Tenn.)
SII6455: 3-isocyanatopropyltriethoxysilane (Obtained from Gelest Morrisville, Pa.)
15 nm silica (Nanostructured & Amorphous Materials Inc. Los Alamos, N. Mex.)
Isopropanol (EMD Chemicals PX1834-1 Darmstadt, Germany)
Tetrahydrofuran (THF) (Obtained from Sigma Aldrich #360589 St. Louis, Mo.)

### Example 1

### LPEI and Silicone Copolymer Synthesis

A copolymer was made by adding 4.2 g Si 1K Di, 1.8 g of LPEI, and 200 mL of isopropanol to a thick-walled glass flask and heated at 150° C. for 18 hours. The polymer solution was then concentrated to 10% (w/v) using a Roto-Vap.

### Example 2

### Surface-Modified 15 nm Silica Nanoparticles

Surface-modified nanoparticles were created by combining 3.0 mL of the copolymer solution from Example 1, 3 g of 15 nm silica, 0.4 mL of triethoxy isocyanopropyl silane, 0.2 mL of ammonium hydroxide, and 100 mL of isopropanol in a reaction vessel. The reaction was left for six hours at room temperature, following which the treated nanoparticles were filtered and washed with isopropanol until all unbound polymer was removed from the particles. After drying overnight in a vacuum, particles were obtained that had superhydrophobic properties.

To test their superhydrophobicity, 0.20 g of the modified 15 nm silica nanoparticles produced by the method described above were placed in to a solution of 2 mL of isopropanol. This coating formulation was painted on a glass microscope slide and air-dried. Using a pipette, water was dropped from 3 cm to the coated surface on an incline. The water was repelled and the treated surface demonstrated superhydrophobicity.

### Example 3

### 15 nm Silica with Silicone Copolymer as Binder

A coating formulation was made by combining 0.50 g of the surface-modified 15 nm silica nanoparticles (produced by the methods of Example 2), 5 mL of the copolymer solution from Example 1, and 20 mL of isopropanol. This coating formulation was painted on a glass microscope slide and air-dried. A pipette was used to drop water from 3 cm to the coated surface on an incline. The water was repelled and the treated surface demonstrated superhydrophobicity. The same coating was subjected to a drop of oil and displayed oleophobic properties.

### Example 4

### 15 nm Silica with Silicone Copolymer and Poly 4-Hydroxystyrene

A coating formulation was made by combining 0.50 g of surface-modified 15 nm silica nanoparticles (produced by the methods of Example 2), 2.5 mL of the copolymer solution from Example 1, 0.25 g of 8,000 dalton poly 4-hydroxystyrene, and 20 mL of isopropanol. This coating formulation was painted on a glass microscope slide and air-dried. A pipette was used to drop water from 3 cm to the coated surface on an incline. The water was repelled, and the treated surface demonstrated superhydrophobicity. The coated microscope slide was then exposed to scotch tape to test coating adherency, with a piece of scotch tape being placed on the film sticky side down and peeled off to see if the coating was removed. The coating remained in place after the scotch tape was removed, and the surface remained hydrophobic. In another experiment, the coating formulation was applied to copy paper, rendering the copy paper surface superhydrophobic.

### Example 5

### Surface Modified 7 nm Silica Particles

3 gm of 7 nm silica particles, 0.3 mL of triethoxy isocyanopropyl silane, and 100 ml of isopropanol were placed in a 200 ml Erlenmeyer flask. The reaction was stirred for 2 hours at room temperature. At this point, 3 mL of the copolymer solution from Example 1 was added to the flask. The reaction was left for six hours at room temperature with stirring, following which the modified particles were filtered and washed with isopropanol until the unbound polymer was removed from the particles. After drying overnight in a vacuum, particles were obtained that demonstrated superhydrophobic properties.

To test superhydrophobicity, 0.20 g of the modified particles were placed into a solution of 2 mL of isopropanol. This solution was painted on a glass microscope slide and air-dried. A pipette was used to drop water from 3 cm to the coated surface on an incline. The water was repelled and the treated surface demonstrated superhydrophobicity.

### Example 6

### 7 nm Silica with Silicone Copolymer

A coating formulation was made by combining 0.50 g of surface-modified 7 nm particles from Example 5, 5 mL of the copolymer solution from Example 1, and 20 mL of isopropanol. This coating formulation was painted on a glass microscope slide and air-dried. A pipette was used to drop water from 3 cm to the coated surface on an incline. The water was repelled and the treated surface demonstrated superhydrophobicity. The same coating was subjected to a drop of oil and displayed oleophobic properties.

### Example 7

### 7 nm Silica with Silicone Copolymer and Poly 4-Hydroxystyrene

A coating formulation was made by combining 0.50 g of surface-modified 7 nm particles from Example 5, 2.5 mL of the solution from Example 1, 0.25 g of 8,000 dalton poly 4-hydroxystyrene, and 20 mL of isopropanol. This coating formulation was painted on a glass microscope slide and dried. A pipette was used to drop water from 3 cm to the coated surface on an incline. Superhydrophobicity was observed. The coating was then exposed to scotch tape in a similar test to the scotch tape test performed in Example 4. The coating remained in place, and the surface remained hydrophobic. In another experiment, the coating formulation was applied to copy paper to yield a superhydrophobic coating.

### Example 8

### 7 nm Silica with Silicone Copolymer and Cellulose Ester

A coating formulation was made by combining 0.50 g of the surface-modified 7 nm particles from Example 5, 2.5 mL of the solution from Example 1, 1.67 mL of a 15% solution of CAB-171-20 in THF, and 20 mL of isopropanol. This solution was homogenized and painted on a glass microscope slide and dried. A pipette was used to drop water from 3 cm to the coated surface on an incline. The water was repelled and the treated surface demonstrated superhydrophobicity.

### Example 9

### BPEI and Silicone Copolymer Synthesis

A copolymer was made by adding 5.7 g Si 1K Di, 2.0 g of BPEI, and 250 mL of isopropanol to a thick-walled glass flask and heated at 130° C. for 16 hours. The polymer solution was then concentrated to 9% (w/v) using a Roto-Vap.

### Example 10

### Chitosan Coated 7 nm Silica Particles

Into a 1 L beaker were placed 4 g of 7 nm silica particles, 8 g of 2% CG110 aqueous solution, and 300 mL distilled water. 0.10 M NaOH was added dropwise to the solution while stirring until the solution pH became neutral. The chitosan precipitated onto the surface of the silica particles when the solution pH became non-acidic. The modified particles were filtered and dried.

### Example 11

### Silicone Modified Nanoparticles

Into a 1 L Erlenmeyer flask were added 1 g chitosan coated particles (from Example 10), 200 mL isopropanol, and 0.16 g of a functionalized polymer selected from the group below. Four different experiments were conducted, each one using one of the following functionalized polymers: 7 k Di, 1 k mono, EMS924, SF8411. For each experiment, the reaction was run for 1 hour with stirring and then the modified particles were filtered and dried.

### Example 12

### Surface Modified 7 nm Particles with Silicone Copolymer Binder System

Five experiments were conducted in total, one using the modified silica particles from Example 10, and four using the modified silicone particles produced using each functionalized polymer described in Example 11. For each experiment, 0.25 g of the particular modified particle was used. This amount of modified particle was placed into a 20 mL scintillation vial, along with 1 mL of the solution from Example 9, 0.2 mL of a 15% solution of CAB-171-15 in THF, and 2 mL of ethyl acetate. For each of these five experiments, the resultant coating formulations were homogenized and painted on a glass microscope slide and a block of plywood. A pipette was used to drop water from 3 cm onto the coated surface on an incline. The water droplets were repelled from each surface, and the treated surfaces all demonstrated superhydrophobic activity.

### Example 13

### Surface Modified 7 nm Particles with UV Curing Silicone as the Binder

Into a 20 mL scintillation vial were added 0.5 g of 8411 modified silica particles from Example 11, 1 mL of UV9300, 0.1 mL Irgacure250, and 4 mL THF. The solution was homogenized and painted on a glass microscope slide. The slides were dried under a UV lamp for 40 minutes. Via pipette, water was dropped from 3 cm to the coated surface on an incline. The water droplets were repelled from the surface, and the treated surface demonstrated superhydrophobic activity.

### Example 14

### Silicone Copolymer Modified 7 nm Silica Particles

Into a 500 mL round bottom flask were added 5 g of 7 nm silica particles prepared according to the methods of Example 5, 0.5 mL of SII6455, and 200 mL Isopropyl alcohol. The mixture was stirred with an overhead stirrer for 75 minutes at room temperature. 6 mL of the silicone copolymer from Example 9 was added and the mixture was stirred for 6 hours. The modified particles were filtered and vacuum dried. The dry particles were sifted to a diameter of 45 μm or less.

### Example 15

### Silicone Copolymer Modified Particles with Silicone Copolymer Binder System

Into a 20 mL scintillation vial were added 0.25 g of the modified silica particles from Example 14, 1 mL of the example 9 solution, 0.2 mL of a 15% solution of CAB-171-15 in THF, and 2 mL of ethyl acetate. This mixture was homogenized and painted on a glass microscope slide and a block of plywood. A pipette was used to drop water from 3 cm to the coated surface on an incline. The water droplets were repelled from the surface and the treated surface demonstrated superhydrophobic activity.

### EQUIVALENTS

While the present invention has been described in terms of specific methods, structures, and compositions it is understood that variations and modifications will occur to those skilled in the art upon consideration of the present invention. For example, the methods and compositions discussed herein can be utilized beyond the preparation of ultraphobic compositions in some embodiments. As well, the features illustrated or described in connection with one embodiment can be combined with the features of other embodiments. Such modifications and variations are intended to be included within the scope of the present invention. Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims.

All publications and references are herein expressly incorporated by reference in their entirety. The terms “a” and “an” can be used interchangeably, and are equivalent to the phrase “one or more” as utilized in the present application. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A coating composition for imparting ultraphobicity, comprising:
a plurality of particles configured to impart texture to a surface; and
a ultraphobic-inducing composition attached to the plurality of particles, the ultraphobic-inducing composition comprising at least one polyamine segment, and a plurality of branch segments attached to the at least one polyamine segment, the plurality of branch segments including at least one of a hydrophobic segment and an oleophobic segment.

2. The coating composition of claim 1, wherein the plurality of branch segments are not covalently bonded to the at least one polyamine segment.

3. (canceled)

4. The coating composition of claim 1, wherein the plurality of particles include a polyamine attached to the particle surface, and the ultraphobic-inducing composition is a binder copolymer composition.

5. (canceled)

6. The coating composition of claim 1, further comprising:
a binder composition combined with the plurality of particles, the plurality of particles imparting the textured surface by protruding from the binder composition.

7. (canceled)

8. The coating composition of claim 6, wherein the binder composition comprises a hydrophobic polymer.

9. The coating composition of claim 6, wherein the coating composition comprises a free standing film.

10. The coating composition of claim 6, wherein a ratio of the plurality of particles to binder composition is less than about one on a weight basis.

11. The coating composition of claim 10, wherein the plurality of particles are more prevalent around an interface of the binder composition relative to a bulk region of the binder composition.

12. The coating composition of claim 6, wherein at least a portion of the plurality of particles form aggregates that increase the opacity of the coating composition to visible light relative to primary particles.

13. The coating composition of claim 6, wherein the binder composition comprises a binder copolymer composition.

14. The coating composition of claim 13, wherein the binder copolymer composition comprises the copolymer composition attached to the plurality of particles.

15. (canceled)

16. The coating composition of claim 1, wherein the plurality of particles comprise at least one of inorganic particles and polymeric particles.

17. (canceled)

18. The coating composition of claim 16, wherein the polymeric particles comprise at least one of polystyrene, silicone, polyethylene, and a fluorinated polymer.

19. (canceled)

20. The coating composition of claim 1, wherein the plurality of particles comprise fibers.

21. The coating composition of claim 1, wherein the at least one polyamine segment includes at least one segment of polydiallylamine, polyalkyleneimines, chitosan, polyallylamine, and polyvinylamine.

22. The coating composition of claim 21, wherein the polyalkyleneimine is branched.

23. (canceled)

24. The coating composition of claim 1, wherein the plurality of branch segments comprise at least one of a fluoro-based segment, a silicone-based segment, a hydrocarbyl-based segment.

25. The coating composition of claim 1, wherein the plurality of branch segments have a molecular weight of at least about 500 daltons.

26. The coating composition of claim 1, wherein the plurality of branch segments comprise a plurality of silicone-based segments.

27. The coating composition of claim 1, wherein the ultraphobic-inducing composition comprises a copolymer composition.

28. (canceled)

29. The coating composition of claim 1, wherein the at least one polyamine segment is attached to the plurality of particles using a multifunctional coupling agent.

30. The coating composition of claim 29, wherein the multifunctional coupling agent comprises a functionality group including at least one of epoxy, hydroxyl, alkoxyl, and halogen.

31. The coating composition of claim 30, wherein the multifunctional coupling agent comprises a silane coupling agent.

32. The coating composition of claim 27, wherein the copolymer composition directly contacts a surface of the plurality of particles.

33. The coating composition of claim 32, wherein at least one polyamine segment comprises chitosan.

34. The coating composition of claim 1, wherein the at least one polyamine segment is attached to at least one of a UV blocker, a dye, a thickener, a dispersing aid, a compatibility aid, a deposition agent, and a hindered amine light stabilizer.

35. A method for rendering a substrate surface ultraphobic, comprising:
contacting the substrate surface with a coating composition, the coating composition comprising:
(i) a plurality of particles configured to impart texture to a surface; and
(ii) an ultraphobic-inducing composition attached to the plurality of particles, the ultraphobic-inducing composition comprising at least one polyamine segment, and a plurality of branch segments attached to the at least one polyamine segment, the plurality of branch segments including at least one of a hydrophobic segment and an oleophobic segment, the contacted substrate surface exhibiting ultraphobic properties.

36-58. (canceled)

59. A method for forming a free-standing film having ultraphobic properties, comprising
forming a template having a surface with at least one ultraphobic property,
contacting the template with a film-forming material to impart a texture of the template surface to the film-forming material, and
removing the film-forming material from the template surface to preserve the texture of the template surface, thereby creating the free-standing film with ultraphobic properties.

60-62. (canceled)
